(19) United States
(12) Patent Application Publication
(10) Pub. No.: US 2024/0003929 A1
(43) Pub. Date: Jan. 4, 2024

(54) NON-CONTACT DISPENSERS AND RELATED SYSTEMS AND METHODS

(71) Applicant: ILLUMINA, INC., San Diego, CA (US)

(72) Inventor: Bryan Crane, San Diego, CA (US)

(21) Appl. No.: 18/215,641

(22) Filed: Jun. 28, 2023

Related U.S. Application Data
(60) Provisional application No. 63/357,469, filed on Jun. 30, 2022.

(51) Int. Cl. G01N 35/10; B01L 3/00

(52) U.S. Cl. CPC G01N 35/1016; G01N 35/1002; B01L 3/52; B01L 2400/0478; B01L 2200/06; B01L 2200/16; B01L 2400/0622

(57) ABSTRACT

Non-contact dispensers and related systems and methods are disclosed. In accordance with an implementation, an apparatus includes a non-contact dispenser includes a body defining an inlet, an outlet, and a flow path fluidly coupling the inlet and the outlet. The non-contact dispenser also includes a first valve to control flow into a portion of the flow path, a second valve to control flow out of the outlet, and a pump positioned between the first valve and the second valve.

### RELATED APPLICATION

This application claims the benefit of and priority to U.S. Provisional Patent Application No. 63/357,469, filed Jun. 30, 2022, the content of which is incorporated by reference herein in its entirety and for all purposes.

### BACKGROUND

DNA libraries may be prepared using work flows to allow samples to be sequenced. Contact dispensers such as pipettes are often used in such work flows.

### SUMMARY

Shortcomings of the prior art can be overcome and benefits as described later in this disclosure can be achieved through the provision of non-contact dispensers and related systems and methods. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, a non-contact dispenser includes a body defining an inlet, an outlet, and a flow path fluidly coupling the inlet and the outlet. The non-contact dispenser also includes a first valve to control flow into a portion of the flow path, a second valve to control flow out of the outlet, and a pump positioned between the first valve and the second valve.

In accordance with a second implementation, a method includes positioning an upstream valve of a non-contact dispenser in an open position; positioning a downstream valve of the non-contact dispenser in a closed position; flowing reagent into an inlet of the non-contact dispenser and through the upstream valve and into a flow path of the non-contact dispenser; positioning the upstream valve in a closed position; positioning the downstream valve in an open position; and moving a plunger of a syringe pump toward the flow path of the non-contact dispenser to dispense the reagent from the outlet.

In further accordance with the foregoing first and/or second implementations, an apparatus and/or method may further include or comprise any one or more of the following:

In accordance with an implementation, the body includes a nozzle that includes the outlet.

In accordance with another implementation, the first valve and the second valve each include diaphragm valves having a diaphragm.

In accordance with another implementation, the first valve has a valve seat defined by the body and the second valve has a valve seat defined by the body.

In accordance with another implementation, the body has first internal curved surfaces that define a first space between the valve seat of the first valve and the first internal curved surfaces to allow movement of the diaphragm of the first valve and the body has second internal curved surfaces that define a second space between the valve seat of the second valve and the second internal curved surfaces to allow movement of the diaphragm of the second valve.

In accordance with another implementation, the body defines a first aperture to allow a pressure to be applied to the diaphragm of the first valve to actuate the first valve and the body defines a second aperture to allow a pressure to be applied to the diaphragm of the second valve to actuate the second valve.

In accordance with another implementation, the first aperture and the second aperture are defined on a first side of the body and the pump is positioned on a second side of the body.

In accordance with another implementation, the pump includes a syringe pump.

In accordance with another implementation, the body defines an aperture and the syringe pump includes a barrel received within the aperture of the body.

In accordance with another implementation, the apparatus includes an actuator to actuate the barrel.

In accordance with another implementation, the apparatus includes adhesive between the barrel and a surface of the body defining the aperture.

In accordance with another implementation, the barrel has a surface that is substantially coplanar with a surface of the body defining the flow path.

In accordance with another implementation, the apparatus includes a film and the body includes a first portion and a second portion. The film positioned between the first portion and the second portion.

In accordance with another implementation, the film defines apertures and the flow path passes through the apertures of the film.

In accordance with another implementation, a second film and an interposer layer, the film is positioned on a first side of the body, the second film is positioned on a second side of the body, and the interposer layer is positioned between the film and the second film.

In accordance with another implementation, the interposer layer defines the flow path.

In accordance with another implementation, the film defines apertures and the flow path passes through the apertures of the film.

In accordance with another implementation, flowing the reagent into the inlet of the non-contact dispenser and through the upstream valve includes filling a barrel of the syringe pump with the reagent.

In accordance with another implementation, the method includes moving the plunger away from the flow path of the non-contact dispenser while filling the barrel of the syringe pump with the reagent.

In accordance with another implementation, moving the plunger away from the flow path of the non-contact dispenser includes moving the plunger using a force exerted by the reagent.

In accordance with another implementation, moving the plunger away from the flow path of the non-contact dispenser includes moving the plunger using an actuator.

In accordance with another implementation, the method includes flowing a wash buffer through the non-contact dispenser.

In accordance with another implementation, the method includes flowing a second reagent through the non-contact dispenser.

In accordance with another implementation, flowing the second reagent through the non-contact dispenser includes opening the downstream valve, opening the upstream valve, and dispensing the second reagent from the outlet of the non-contact dispenser.

In accordance with another implementation, flowing the second reagent through the non-contact dispenser includes the downstream valve and the upstream valve being in an open position.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect described herein. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a cross-sectional view of an implementation of a non-contact dispenser that can be used to implement the non-contact dispenser of FIG. 1.

FIG. 3 is a cross-sectional view of another implementation of a non-contact dispenser that can be used to implement the non-contact dispenser of FIG. 1.

FIG. 4 is a cross-sectional view of an implementation of another non-contact dispenser that can be used to implement the non-contact dispenser of FIG. 1.

FIG. 5 is a cross-sectional view of an implementation of another non-contact dispenser that can be used to implement the non-contact dispenser of FIG. 1.

FIG. 6 illustrates a flowchart describing a process for using the non-contact dispensers of FIGS. 1, 2, 3, 4, and 5 or any of the other implementations disclosed herein.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

At least one aspect of this disclosure is related to systems that automate library preparation processes, sample preparation processes, or other similar processes, and use less consumables, thereby reducing a footprint of the system and an amount of solid waste produced. The systems disclosed use a non-contact dispenser(s) that has an inline and relatively straight fluid path that reduces the presence of corners, allows the non-contact dispensers to be easily flushed, and/or reduces manufacturing complexity. The non-contact dispensers can switch between dispensing different reagents as a result using the same non-contact dispenser without those reagents adversely interacting with one another. Dead volume of reagent is also reduced using the disclosed implementations.

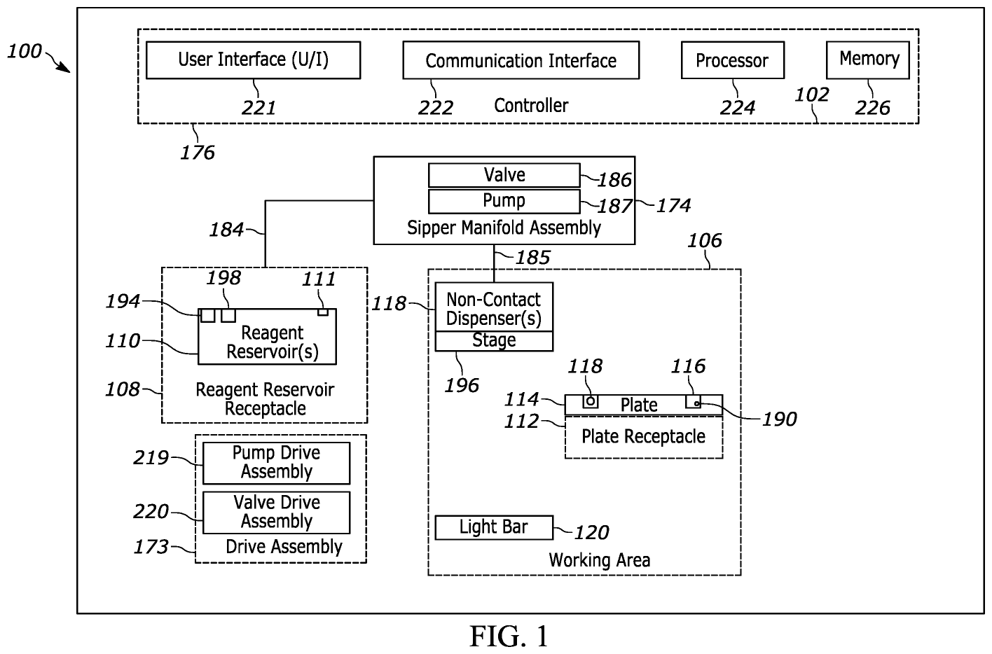

FIG. 1 illustrates a schematic diagram of an implementation of a system 100 in accordance with the teachings of this disclosure. The system 100 may be used to automatically, easily, and efficiently prepare DNA libraries for sequencing applications, for example. The system 100 may perform DNA library preparation workflows that include amplification processes, cleanup processes, library normalization processes, and/or pooling processes in some implementations. The system 100 may perform workflows such as whole genome sequencing (WGS) workflows, DNA & RNA enrichment workflows, methylation workflows, split-pool amplicon workflows, and/or amplicon workflows, among others. The DNA library preparation workflow can be performed on any number of samples such as between one sample and twenty-four samples, forty-eight samples, ninety-six samples, or more. The system 100 thus allows for variable batch processing. Other uses of the system 100 may prove suitable, however.

The system 100 includes a working area 106 and a reagent reservoir receptacle 108 to receive a reagent reservoir 110 in the implementation shown. The reagent reservoir 110 contains reagent 111. The reagent reservoir receptacle 108 may alternatively be positioned above the working area 106.

The working area 106 includes a plate receptacle 112 that receives a plate 114 having a well 116 and a non-contact dispenser 118 that dispenses the reagent 111 from the reagent reservoir 110 into the well 116 of the plate 114. The plate 114 may have any number of wells 116 such as twenty-four, forty-eight, or ninety-six wells. Another number of wells 116 is suitable, however.

The non-contact dispenser 118 is fluidly coupled to the reagent reservoir 110. The non-contact dispenser 118 may alternatively aspirate reagent 111 from the reagent reservoir 110 using tips, for example, and dispense the reagent 111 into the wells 116 of the plate 114. The non-contact dispenser 118 may not be fluidly coupled to the reagent reservoir 110 in such implementations. The working area 106 may also include a light bar 120 that may be used to degrade oligonucleotides. The light bar 120 may be a high power ultraviolet light (UV) light bar that is regularly used throughout a workflow to repeatedly degrade oligonucleotides to deter cross contamination in some implementations.

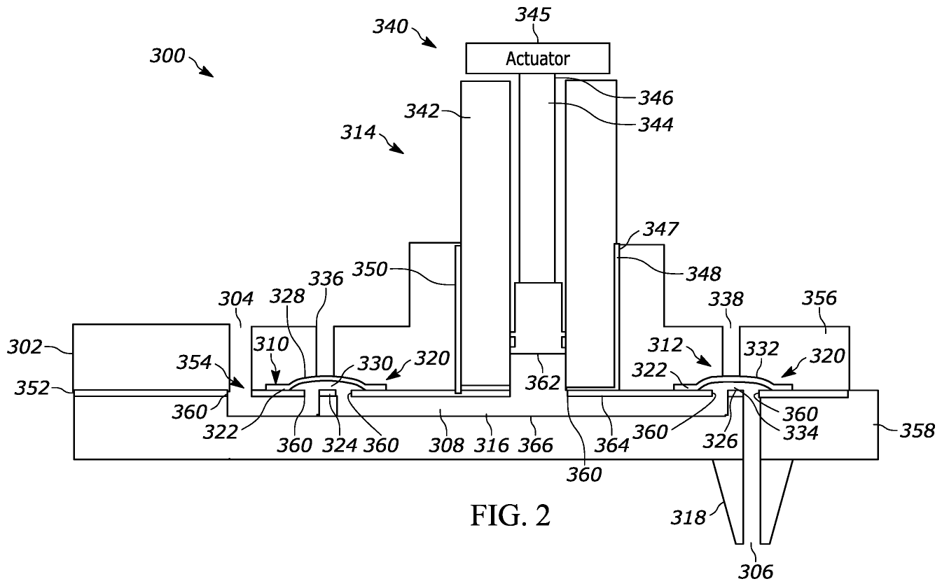

The system 100 also includes a drive assembly 173, a sipper manifold assembly 174, and a controller 176. The sipper manifold assembly 174 may be coupled to a corresponding number of the reagent reservoirs 110 via reagent sippers 184. The reagent reservoir(s) 110 may contain fluid (e.g., reagent 111 and/or another reaction component). The sipper manifold assembly 174 includes a plurality of ports in some implementations, where each port of the sipper manifold assembly 174 may receive one of the reagent sippers 184. The reagent sippers 184 may be referred to as fluidic lines. The sipper manifold assembly 174 also includes a valve 186 that may be selectively actuated to control the flow of fluid through a fluidic line 185. The sipper manifold assembly 174 also includes a pump 187 to selectively flow the reagent(s) 111 from the reagent reservoir 110, through the reagent sipper 184, through the fluidic line 185, and out of the non-contact dispenser 118. The pump 187 may additionally or alternatively be used to actuate valves of the non-contact dispenser 118 as discussed in connection with FIG. 2.

The valve 186 may be implemented by a rotary valve, a pinch valve, a flat valve, a solenoid valve, a check valve, a piezo valve, etc. Other fluid control devices may prove suitable. The pump 187 may be implemented by a syringe pump, a peristaltic pump, and/or a diaphragm pump. Other types of fluid transfer devices may be used, however. The controller 176 is electrically and/or communicatively coupled to the non-contact dispenser 118, the sipper manifold assembly 174, the valve 186, the pump 187, and the drive assembly 173 to perform various functions as disclosed herein. The sipper manifold assembly 174 may alternatively be omitted.

Different wells 116 of the plate 114 may contain different samples 188. The samples 188 may be a biological sample derived from a human, animal, plant, bacteria, or fungi. Other sources of obtaining the biological samples may prove suitable. Beads 190 may be dispensed into the wells 116 and the non-contact dispenser 118 may be aligned with the plate 114 in operation. The non-contact dispenser 118 dispenses a first reagent 194 from the reagent reservoir 110 into the well 116 of the plate 114. The first reagent 194 may be a bead buffer and the sample 188 may bind to the beads 190 in the presence of the bead buffer.

The non-contact dispenser 118 may be able to jet dispense with adequate liquid velocity to enable jet mixing in some implementations. The accuracy of the non-contact dispenser 118 may allow less reagent to be used as compared to manual workflows and between about ¼ of the reagent to about % of the reagent may be used, for example. The non-contact dispenser 118 can deliver volumes of reagent of about 1 μL with a precision error of less than about 2% coefficient of variation (CV) and an accuracy error of less than about 4% such that the total fluid volume error is less than about 10%, in some examples. The non-contact dispenser 118 may deliver about 50 μL to each well 116 of the plate 114 in about 48 seconds (sec) for larger volume deliveries and may delivery about 5 μL to each well 116 of the plate 114 in about 24 seconds (sec) for smaller volume deliveries.

A stage 196 may be coupled to and adapted to move the non-contact dispenser 118 to allow the non-contact dispenser 118 to dispense liquid such as the first reagent 194 into the well 116 of the plate 114. The stage 196 may be a z-stage or an x-y-x stage in some implementations. The stage 196 may be an x-y-z stage in implementations when the non-contact dispenser 118 is positioned to aspirate the reagent 111 directly from the reagent reservoir 110, for example. The stage 196 may alternatively be omitted.

The non-contact dispenser 118 may be aligned with the plate 114 after the first reagent 194 is removed and the non-contact dispenser 118 dispenses a second reagent 198 from the reagent reservoir 110 into the well 116 of the plate 114. The second reagent 198 may be an elution buffer that releases the sample 188 from being bound to the beads 190 and, specifically, releases DNA associated with the sample 188 from being bound to the beads 190. The non-contact dispenser 118 may be used to perform additional or different portions of a workflow(s), however.

The drive assembly 173 includes a pump drive assembly 219 and a valve drive assembly 220. The pump drive assembly 219 may be adapted to interface with the pump 187 to pump fluid from the reagent reservoir 110 to the non-contact dispenser 118. The valve drive assembly 220 may be adapted to interface with the valve 186 to control the position of the valve 186.

The controller 176 includes a user interface 221, a communication interface 222, one or more processors 224, and a memory 226 storing instructions executable by the one or more processors 224 to perform various functions including the disclosed implementations. The user interface 221, the communication interface 222, and the memory 226 are electrically and/or communicatively coupled to the one or more processors 224.

In an implementation, the user interface 221 receives input from a user and provides information to the user associated with the operation of the system 100 and/or an analysis taking place. The user interface 221 may include a touch screen, a display, a key board, a speaker(s), a mouse, a track ball, and/or a voice recognition system. The touch screen and/or the display may display a graphical user interface (GUI).

In an implementation, the communication interface 222 enables communication between the system 100 and a remote system(s) (e.g., computers) using a network(s). The network(s) may include an intranet, a local-area network (LAN), a wide-area network (WAN), the intranet, etc. Some of the communications provided to the remote system may be associated with an amplification process(es), a cleanup process(es), a library normalization process(es), and/or a pooling process(es)), etc. generated or otherwise obtained by the system 100. Some of the communications provided to the system 100 may be associated with an amplification process(es), a cleanup process(es), a library normalization process(es), and/or a pooling process(es) to be executed by the system 100.

The one or more processors 224 and/or the system 100 may include one or more of a processor-based system(s) or a microprocessor-based system(s). In some implementations, the one or more processors 224 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 226 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

FIG. 2 is a cross-sectional view of an implementation of a non-contact dispenser 300 that can be used to implement the non-contact dispenser 118 of FIG. 1. The non-contact dispenser 300 may be referred to as a system. The non-contact dispenser 300 may be self-priming and/or self-washing and may be used to dispense discrete droplets and/or to dispense a long jet. The non-contact dispenser 300 includes a body 302 defining an inlet 304, an outlet 306, and a flow path 308 fluidly coupling the inlet 304 and the outlet 306. The non-contact dispenser also includes a first valve 310, a second valve 312, and a pump 314 positioned between the first valve 310 and the second valve 312. The first valve 310 controls the flow of fluid into a portion 316 of the flow path 308 and the second valve 312 controls the flow of fluid out of the outlet 306. The first valve 310 may be referred to as an upstream valve and the second valve 312 may be referred to as a downstream valve.

The inlet 304 may be fluidly coupled to a selector valve leading to a selection of different liquids, fluidly coupled to one or more sources that are at ambient pressure, fluidly coupled to one or more sources that are subject to pressure above ambient, and/or fluidly coupled to one more sources that themselves are a liquid displacement device (such as reservoir with a diaphragm or a coarse syringe as a reservoir), as an example. The liquid sources that include positive pressure or displacement may enable flushing the non-contact dispenser 300 of air and/or rapidly priming the non-contact dispenser 300. Positive pressure or displacement may also be used as a lesser complex approach of low accuracy liquid dispensing, for example, using only diaphragm valve to control an “open time” for a pressurized reagent source

The body 302 also has a nozzle 318 in the implementation shown that includes the outlet 306 and the first valve 310 and the second valve 312 are each diaphragm valves 320 having a diaphragm 322. The nozzle 318 may alternatively be a separate component from the body 302 that is coupled to the body 302. The nozzle 318 being a separate component may enable the nozzle 318 to have material properties that allows for lower surface tension and/or for threshold wall thicknesses and/or orifice diameters to be satisfied. The diaphragm 322 may be relatively thin and/or relatively stiff to reduce contributions to non-contact dispenser 300 compliance, for example.

The first valve 310 has a valve seat 324 defined by the body 302 and the second valve 312 has a valve seat 326 defined by the body 302. The body 302 also has first internal curved surfaces 328 that define a first space 330 between the valve seat 324 of the first valve 310 and the first internal curved surfaces 328 to allow movement of the diaphragm 322 of the first valve 310 between the open position shown in FIG. 2 and a closed position. The body 302 similarly has second internal curved surfaces 332 that define a second space 334 between the valve seat 326 of the second valve 312 and the second internal curved surfaces 332 to allow movement of the diaphragm 322 of the second valve 312 between the open position shown in FIG. 2 and a closed position. The curve surfaces 328, 332 may provide a seat for the valves 310, 312.

The body 302 defines a first aperture 336 to allow a pressure to be applied to the diaphragm 322 of the first valve 310 to actuate the first valve 310 and the body 302 defines a second aperture 338 to allow a pressure to be applied to the second valve 312 to actuate the second valve 312. The valves 310, 312 may be opened by positive hydraulic pressure of the dispensed liquid and the valves 310, 312 may be closed by applying the pressure to the diaphragms 322. The valves 310, 312 may alternatively be actuated in different ways including using negative pneumatic pressure and/or using a mechanical force, however. An actuator having an actuator rod may be provided to actuate the valves 310, 312 using mechanical force, for example.

The pump 314 is a syringe pump 340 in the implementation shown having a barrel 342 and a plunger 344 that is movable within the barrel 342 to actuate the syringe pump 340. The barrel 342 may be made of glass having accurate dimensions and/or low manufacturing tolerances. The plunger 344 may also be referred to as a piston and may include a relatively stiff material such as Teflon™. An actuator 345 may be used to move the plunger 344. A coupling 346 is provided between the actuator 345 and the plunger 344. The coupling 346 may allow reduced or zero backlash. The plunger 344 may alternatively or additionally carry a linear encoder to enable tailored motion profiles if the coupling 346 allows backlash as an example.

The actuator 345 may be implemented by or include a piezoelectric actuator, a voice coil, a high-bandwidth actuator, a lead screw, and/or a ball nut having a zero backlash spring mechanism. The actuator 345 may be moved with a tailored motion profile. The syringe pump 340 may have a diameter of approximately 2 millimeters (mm), a 0.33 mm stroke for approximately 1 microliter (μL), a 8.5 mm stroke for approximately 25 μL, and a 17 mm stroke for approximately 50 μL. The syringe pump 340 may be sized to have different strokes that draw different volumes, however.

The body 302 defines an aperture 347 into which the barrel 342 of the syringe pump 340 is received. Adhesive 348 may be positioned between the barrel 342 and a surface 350 of the body 302 defining the aperture 347 to couple the syringe pump 340 to the body 302. The adhesive 348 may be drawn between the barrel 342 and the surface 350 of the body 302 by surface tension. The syringe pump 340 may be coupled to the body 302 in different ways such as an interference fit between the syringe pump 340 and the body 302, however.

The non-contact dispenser 300 also includes a film 352 that may be used to cap a microfluidic circuit 354 of the non-contact dispenser 300. The body 302 includes a first portion 356 and a second portion 358 and the film 352 is positioned between the first portion 356 and the second portion 358. The film 352 also defines apertures 360 through which the flow path 308 of the non-contact dispenser 300 passes.

The non-contact dispenser 300 may be primed prior to use. The plunger 344 may be in a full down position to do so, where a bottom face 362 of the plunger 344 is substantially in-plane with a top surface 364 of the flow path 308. The film 352 may be used to reduce a distance between the bottom face 362 of the plunger 344 and the flow path 308 when the plunger 344 is in the full down position. The distance being smaller may reduce the likelihood that air is trapped at the bottom face 362.

The plunger 344 may be moved upward to pull fresh reagent into the flow path 308 while the first valve 310 is open and the second valve 312 is closed. The first valve 310 is then closed, the second valve 312 is opened, and the plunger 344 is moved downward to exhaust air out of the outlet 306. The priming process may be repeated a number of times to remove air from the flow path 308. The non-contact dispenser 300 may determine the presence of air in the flow path 308 after the flow path 308 is primed with fluid by closing the first valve 310 and closing the second valve 312 and attempting to move the plunger 344 downward. Movement of the plunger 344 over a threshold distance may be indicative of air in the flow path 308. The plunger 344 may be moved downward into engagement with a lower surface 366 of the flow path 308 to remove any bubbles that are attached to the plunger 344. The plunger 344 may have a shape that enables the plunger 344 to touch the lower surface 366, as a result.

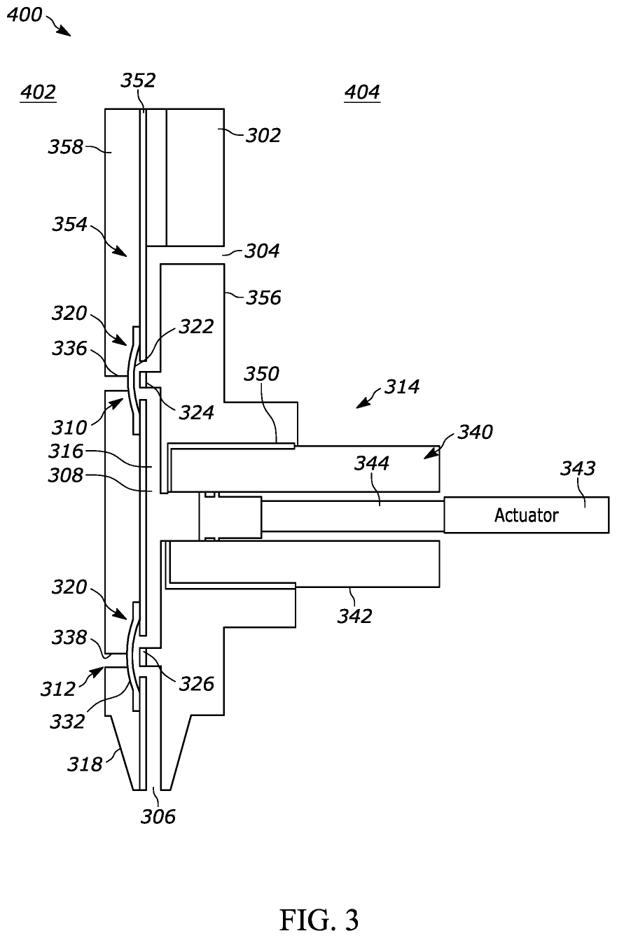

FIG. 3 is a cross-sectional view of an implementation of a non-contact dispenser 400 that can be used to implement the non-contact dispenser 118 of FIG. 1. The non-contact dispenser 400 is similar to the non-contact dispenser 300 of FIG. 2. The non-contact dispenser 400 of FIG. 3 includes the apertures 336, 338 and the diaphragm valves 320 on a first side 402 of the non-contact dispenser 400 and the syringe pump 340 is on a second side 404 of the non-contact dispenser 400. The diaphragm valves 320 can be positioned closer to the syringe pump 340 as a result of the diaphragm valves 320 being on the first side 402 of the non-contact dispenser 400. The non-contact dispenser 400 also shows the nozzle 318 and the portion 316 of the flow path 308 being coaxial. The coaxial arrangement of the nozzle 318 and the portion 316 of the flow path 308 allows the non-contact dispenser 400 to be easily flushed.

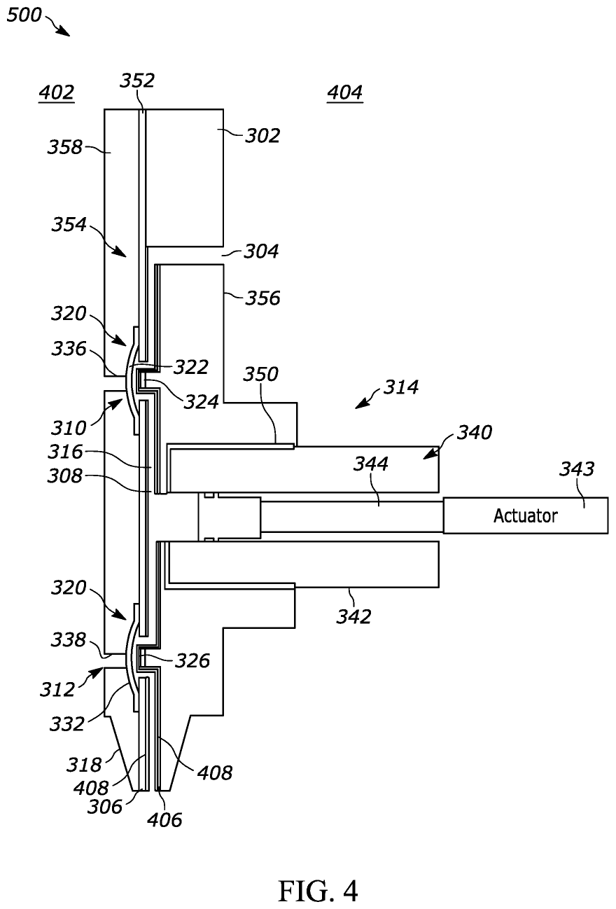

FIG. 4 is a cross-sectional view of an implementation of a non-contact dispenser 500 that can be used to implement the non-contact dispenser 118 of FIG. 1. The non-contact dispenser 500 of FIG. 4 is similar to the non-contact dispenser 400 of FIG. 3. The non-contact dispenser 500 of FIG. 4 also includes a second film 406 and an interposer layer 408, however. The interposer layer 408 may be referred to as a microfluidic interposer. The film 352 is shown positioned on the first side 402 of the non-contact dispenser 400, the film 406 is shown positioned on the second side 404 of the non-contact dispenser 300, and the interposer layer 408 is shown defining the flow path 308. The interposer layer 408 is positioned between the films 352, 406.

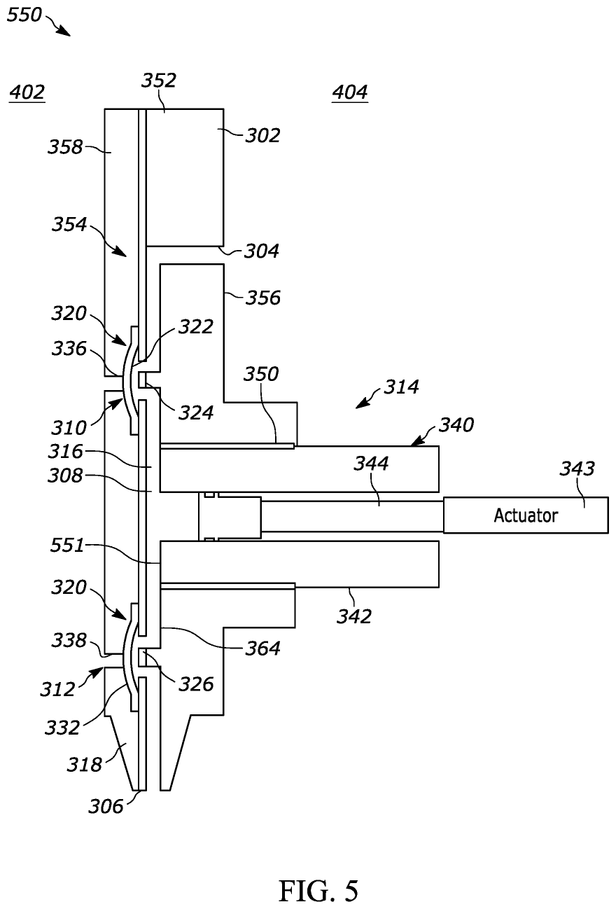

FIG. 5 is a cross-sectional view of an implementation of a non-contact dispenser 550 that can be used to implement the non-contact dispenser 118 of FIG. 1. The non-contact dispenser 550 of FIG. 5 is similar to the non-contact dispenser 400 of FIG. 3. The non-contact dispenser 550 of FIG. 5 has the barrel 342 having a surface 551 that is substantially coplanar with the top surface 364 of the body 302 defining the flow path 308. As set forth herein, the phrase “substantially coplanar” means about +/−5° of coplanar including coplanar itself.

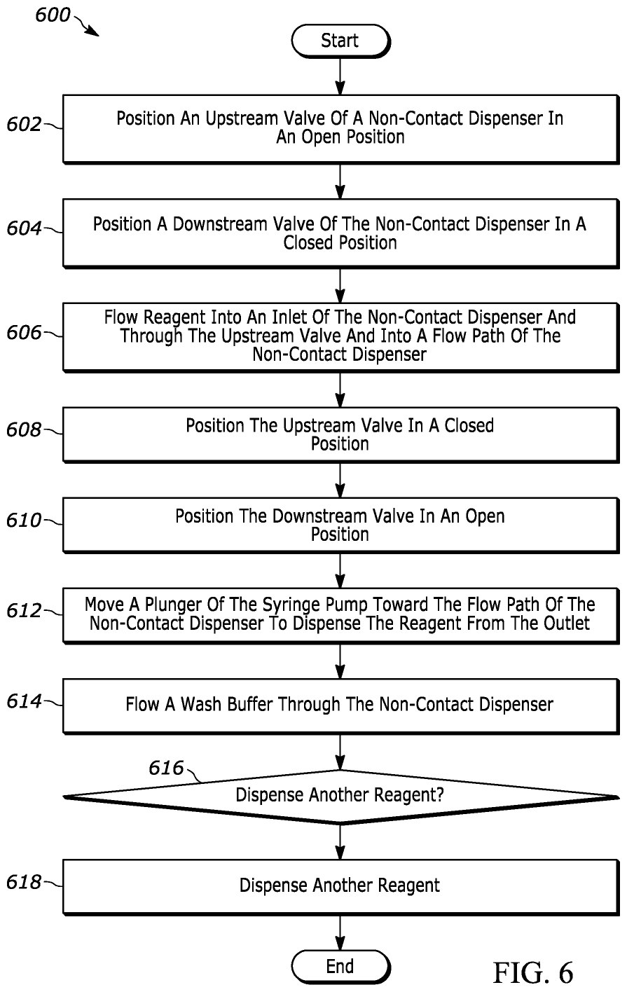

FIG. 6 illustrates a flowchart describing a process for using the non-contact dispensers 118, 300, 400, 500, 550 of FIGS. 1, 2, 3, 4, 5 or any of the other implementations disclosed herein. The order of execution of the blocks may be changed, and/or some of the blocks described may be changed, eliminated, combined and/or subdivided into multiple blocks.

The process begins with the upstream valve 310 of the non-contact dispenser 118, 300, 400, 500, 550 being positioned in an open position (Block 602) and the downstream valve 312 of the non-contact dispenser 118, 300, 400, 500, 550 being positioned in a closed position (Block 604). Reagent 111 is flowed into the inlet 304 of the non-contact dispenser 118, 300, 400, 500, 550 and through the upstream valve 310 and into the flow path 308 of the non-contact dispenser 118, 300, 400, 500, 550 (Block 606). Flowing the reagent 111 into the inlet 304 of the non-contact dispenser 118, 300, 400, 500, 550 and through the upstream valve 310 may include filling the barrel 442 of the syringe pump 340 with the reagent 111. The reagent 111 may flow into the non-contact dispenser 118, 300, 400, 500, 550 using positive pressure or the reagent 111 may be drawn into the non-contact dispenser 118, 300, 400, 500, 550 using the syringe pump 340. The plunger 344 may be moved away from the flow path 308 of the non-contact dispenser 118, 300, 400, 500, 550 while the barrel 442 of the syringe pump 340 is being filled with the reagent 111. The plunger 344 may be moved away from the flow path 308 of the non-contact dispenser 118, 300, 400, 500, 550 using a force exerted by the reagent 111 and/or by using the actuator 345.

The upstream valve 310 is positioned in a closed position (Block 608), the downstream valve 312 is positioned in an open position (Block 610), and the plunger 344 of the syringe pump 340 is moved toward the flow path 308 of the non-contact dispenser 118, 300, 400, 500, 550 to dispense the reagent 111 from the outlet 306 (Block 612).

The upstream valve 310 and the downstream valve 312 may be both positioned in the open position when dispensing larger volumes of the reagent 111 and the plunger 344 may remain in a fixed position or a relatively fixed position and, thus, may not move when the larger volume of the reagent 111 is dispensed. The plunger 344 may alternatively move when the larger volume of the reagent 111 is dispensed.

A wash buffer is flowed through the non-contact dispenser 118, 300, 400, 500, 550 (Block 616). The process determines whether to dispense another reagent 111 (Block 618). The other reagent 111 may be the first reagent 194, the second reagent 198, etc. The second reagent 137 can be flowed through the non-contact dispenser 118, 300, 400, 500, 550 by opening the downstream valve 312, opening the upstream valve 310, and dispensing the second reagent 198 from the outlet 306 of the non-contact dispenser 118, 300, 400, 500, 550. The second reagent 198 can thus be flowed through the non-contact dispenser 118, 300, 400, 500, 550 by having the downstream valve 312 and the upstream valve 310 in an open position.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In one example, these terms include situation where there is no variation −0%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a non-contact dispenser, comprising:
a body defining an inlet, an outlet, and a flow path fluidly coupling the inlet and the outlet;
a first valve to control flow into a portion of the flow path;
a second valve to control flow out of the outlet; and
a pump positioned between the first valve and the second valve.

2. The apparatus of claim 1, wherein the body comprises a nozzle that includes the outlet.

3. The apparatus of claim 1, wherein the first valve and the second valve each comprise diaphragm valves having a diaphragm.

4. The apparatus of claim 1, wherein the first valve has a valve seat defined by the body and the second valve has a valve seat defined by the body.

5. The apparatus of claim 4, wherein the body has first internal curved surfaces that define a first space between the valve seat of the first valve and the first internal curved surfaces to allow movement of the diaphragm of the first valve and the body has second internal curved surfaces that define a second space between the valve seat of the second valve and the second internal curved surfaces to allow movement of the diaphragm of the second valve.

6. The apparatus of claim 3, wherein the body defines a first aperture to allow a pressure to be applied to the diaphragm of the first valve to actuate the first valve and the body defines a second aperture to allow a pressure to be applied to the diaphragm of the second valve to actuate the second valve.

7. The apparatus of claim 6, wherein the first aperture and the second aperture are defined on a first side of the body and the pump is positioned on a second side of the body.

8. The apparatus of claim 1, wherein the pump comprises a syringe pump.

9. The apparatus of claim 8, wherein the body defines an aperture and wherein the syringe pump comprises a barrel received within the aperture of the body.

10. The apparatus of claim 9, further comprising an actuator to actuate the barrel.

11. The apparatus of claim 9, further comprising adhesive between the barrel and a surface of the body defining the aperture.

12. The apparatus of claim 9, wherein the barrel has a surface that is substantially coplanar with a surface of the body defining the flow path.

13. The apparatus of claim 1, further comprising a film and wherein the body includes a first portion and a second portion, the film positioned between the first portion and the second portion.

14. The apparatus of claim 13, wherein the film defines apertures and the flow path passes through the apertures of the film.

15. The apparatus of claim 13, further comprising a second film and an interposer layer, the film is positioned on a first side of the body, the second film is positioned on a second side of the body, and the interposer layer is positioned between the film and the second film.

16. The apparatus of claim 15, wherein the interposer layer defines the flow path.

17. A method, comprising:
positioning an upstream valve of a non-contact dispenser in an open position;
positioning a downstream valve of the non-contact dispenser in a closed position;
flowing reagent into an inlet of the non-contact dispenser and through the upstream valve and into a flow path of the non-contact dispenser;
positioning the upstream valve in a closed position;
positioning the downstream valve in an open position; and
moving a plunger of a syringe pump toward the flow path of the non-contact dispenser to dispense the reagent from the outlet.

18. The method of claim 17, wherein flowing the reagent into the inlet of the non-contact dispenser and through the upstream valve comprises filling a barrel of the syringe pump with the reagent.

19. The method of claim 17, further comprising moving the plunger away from the flow path of the non-contact dispenser while filling the barrel of the syringe pump with the reagent.

20. The method of claim 19, wherein moving the plunger away from the flow path of the non-contact dispenser comprises moving the plunger using a force exerted by the reagent.

21. The method of claim 19, wherein moving the plunger away from the flow path of the non-contact dispenser comprises moving the plunger using an actuator.

22. The method of claim 17, further comprising flowing a wash buffer through the non-contact dispenser.

23. The method of claim 22, further comprising flowing a second reagent through the non-contact dispenser.

24. The method of claim 23, wherein flowing the second reagent through the non-contact dispenser comprises opening the downstream valve, opening the upstream valve, and dispensing the second reagent from the outlet of the non-contact dispenser.

25. The method of claim 23, wherein flowing the second reagent through the non-contact dispenser comprises the downstream valve and the upstream valve being in an open position.
